(19) United States
(12) Patent Application Publication
(10) Pub. No.: US 2014/0233380 A1
(43) Pub. Date: Aug. 21, 2014

(54) METHOD AND APPARATUS FOR MANAGING QUALITY OF SERVICE OF UPLINK IN WIRELESS COMMUNICATION SYSTEM

(71) Applicant: LG ELECTRONICS INC., Seoul (KR)

(72) Inventors: Hyunsook Kim, Anyang-si (KR); Laeyoung Kim, Anyang-si (KR); Taehyeon Kim, Anyang-si (KR)

(73) Assignee: LG ELECTRONICS INC., Seoul (KR)

(21) Appl. No.: 14/350,348

(22) PCT Filed: Oct. 26, 2012
(86) PCT No.: PCT/KR2012/008875

§ 371 Date: Apr. 7, 2014

Related U.S. Application Data
(60) Provisional application No. 61/551,935, filed on Oct. 27, 2011.

(51) Int. Cl. H04L 12/851

(52) U.S. Cl. CPC H04L 47/24
USPC 370/230

(57) ABSTRACT

A method of managing quality of service (QoS) of an uplink of a terminal includes the steps of: when the terminal supports reflective QoS, transmitting an instruction regarding the reflective QoS to a network node; and receiving from the network node an instruction on whether the reflective QoS is to be applied in response to the instruction regarding the reflective QoS.

### TECHNICAL FIELD

Following description relates to a wireless communication system, and more particularly, to a method of managing or securing quality of service of uplink and an apparatus therefor.

### BACKGROUND ART

In 3GPP (3^{rd} generation partnership project), which is one of international mobile communication standardization organizations, a discussion to support a fixed broadband access network has been started at the end of 2009. Specifically, in case that 3GPP system and a broadband system are interworking, in order to have a common and integrated system for a charging, authentication, QoS (quality of service) and the like used to be supported by an individual system, standardization for information required to be transceived between systems, interface, and the like is in progress.

According to the interworking technology of the 3GPP system and the fixed broadband access network, in terms of the 3GPP system, since it is able to secure QoS for a wired backhaul network section when the 3GPP system transmits a data for offloading via WLAN (wireless local area network) or the like, it is able to enlarge a service area. And, in terms of the fixed broadband system, since a service of a wired network can be ultimately serviced via a 3GPP mobile communication system, it is able to enlarge a service area.

When the 3GPP system and the fixed broadband access network are interworking, an uplink QoS can be implemented in a manner of reflecting downlink QoS. In particular, a user equipment can be configured to transmit uplink data of a level identical to a QoS level of a received downlink data. This sort of QoS management or a securing mechanism can be called a reflective QoS scheme.

### DISCLOSURE OF THE INVENTION

### Technical Task

In order to implement a reflective QoS, a user equipment should be equipped with a capability of the reflective QoS. According to a legacy system, the capability of the reflective QoS is defined as an optional function. In particular, the user equipment may or may not implement the reflective QoS. According to the legacy system, whether to apply the reflective QoS to the user equipment operating in 3GPP system is determined by a network side. When the user equipment attaches to the system, the network informs the user equipment of a decision on whether the reflective QoS is applied.

In the aforementioned operation of the legacy system, it is difficult for the network side to know whether the user equipment supports the reflective QoS. In particular, the network determines whether to apply the reflective QoS irrespective of whether the user equipment supports the reflective QoS. Hence, although the network determines or indicates that the reflective QoS is applied to the user equipment, if the user equipment does not support the reflective QoS, the reflective QoS cannot be applied. The aforementioned network operation may correspond to an unnecessary or inefficient operation.

Hence, a technical task of the present invention is to provide a method of more efficiently securing uplink QoS of the user equipment in case that 3GPP system and the fixed broadband access network are interworking.

Technical tasks obtainable from the present invention are non-limited the above-mentioned technical task. And, other unmentioned technical tasks can be clearly understood from the following description by those having ordinary skill in the technical field to which the present invention pertains.

### Technical Solution

Accordingly, the present invention is directed to an apparatus for and method thereof that substantially obviate one or more of the problems due to limitations and disadvantages of the related art.

In order to solve the aforementioned technical task, according to one embodiment of the present invention, a method of managing uplink quality of service (QoS) of a user equipment includes the steps of if the user equipment supports a reflective QoS, transmitting an indication on the reflective QoS to a network node and receiving an indication on whether the reflective QoS is applied from the network node in response to the indication of the user equipment.

In order to solve the aforementioned technical task, according to a different embodiment of the present invention, a method of supporting uplink quality of service (QoS) of a user equipment, which is supported by a network node, includes the steps of if the user equipment supports a reflective QoS, receiving an indication on the reflective QoS from the user equipment by the network node and transmitting an indication on whether the reflective QoS is applied to the user equipment by the network node in response to the indication of the user equipment.

In order to solve the aforementioned technical task, according to a further different embodiment of the present invention, a user equipment device managing uplink quality of service (QoS) includes a transceiving module configured to transceive a signal with an external and a processor configured to control the user equipment device, if the user equipment supports a reflective QoS, the processor configured to transmit an indication on the reflective QoS to a network node using the transceiving module, the processor configured to receive an indication on whether the reflective QoS is applied from the network node in response to the indication of the user equipment using the transceiving module.

In order to solve the aforementioned technical task, according to a further different embodiment of the present invention, a network node device supporting management of uplink quality of service (QoS) of a user equipment includes a transceiving module configured to transceive a signal with an external and a processor configured to control the network node device, if the user equipment supports a reflective QoS, the processor configured to receive an indication on the reflective QoS from the user equipment using the transceiving module, the processor configured to transmit an indication on whether the reflective QoS is applied to the user equipment in response to the indication of the user equipment using the transceiving module.

In the embodiments according to the present invention, following description can be commonly applied.

The indication on the reflective QoS can be transmitted to the network node in the course of performing an authentication process of the user equipment.

A decision on whether the reflective QoS is applied can be included in the authentication process of the user equipment.

Whether to apply the reflective QoS can be determined based on at least one selected from the group consisting of a capability of the user equipment related to the reflective QoS, a type of access, a local policy, and a policy of a HPLMN (Home Public Land Mobile Network) service provider.

The network node may correspond to a 3GPP (3^{rd} Generation Partnership Project) AAA (Authentication, Authorization and Accounting) server.

The method of managing the UL QoS can be applied to interworking between a 3GPP and a fixed broadband access.

A DSCP (Differentiated Service Code Point) marking can be performed by the user equipment using the reflective QoS.

The user equipment can access via a wireless LAN.

The reflective QoS can be applied to a traffic, which is routed to an EPC (Evolved Packet Core) via the wireless LAN.

The reflective QoS can be configured in an application granularity, a PDN (Packet Data Network) connection granularity, or an APN (Access Point Name) granularity. It is to be understood that both the foregoing general description and the following detailed description are exemplary and explanatory and are intended to provide further explanation of the invention as claimed.

### Advantageous Effects

According to the present invention, it is able to provide a method of more efficiently securing uplink QoS of a user equipment in case that 3GPP system and a fixed broadband access network are interworking.

Effects obtainable from the present invention may be non-limited by the above mentioned effect. And, other unmentioned effects can be clearly understood from the following description by those having ordinary skill in the technical field to which the present invention pertains.

### DESCRIPTION OF DRAWINGS

The accompanying drawings, which are included to provide a further understanding of the invention and are incorporated in and constitute a part of this specification, illustrate embodiments of the invention and together with the description serve to explain the principles of the invention.

FIG. 1 is a schematic diagram for a structure of an EPS (evolved packet system) including an EPC (evolved packet core);

FIG. 2 is a diagram for one of EPS structures supporting a non-3GPP access;

FIG. 3 is a diagram for an EPS structure supporting a non-3GPP access network depicted in detail for a case of a trusted non-3GPP access network and a case of an untrusted non-3GPP access network;

FIG. 4 is a diagram for explaining a protocol used for a non-3GPP access network;

FIG. 5 is a diagram for an (e)Node B and a H(e)Node B;

FIG. 6 to FIG. 8 is a diagram for a BBF interworking network reference model;

FIG. 9 is a diagram for explaining an S2b bearer;

FIG. 10 is a diagram for explaining a packet classification and a packet forwarding operation in an interworking scenario of a 3GPP system and a fixed broadband system;

FIG. 11 is a diagram for explaining a DSCP (differentiated service code point);

FIG. 12 is a flowchart indicating a method of determining whether to apply a reflective QoS according to one example of the present invention;

FIG. 13 is a flowchart indicating a method of determining whether to apply a reflective QoS according to a different example of the present invention;

FIG. 14 is a flowchart indicating a method of determining whether to apply a reflective QoS according to a further different example of the present invention;

FIG. 15 is a flowchart indicating a method of determining whether to apply a reflective QoS according to a further different example of the present invention;

FIG. 16 is a diagram for a configuration of a preferred embodiment for a user equipment device and a network node device according to one example of the present invention.

### BEST MODE

### Mode for Invention

The embodiments in the following description may correspond to combinations of elements and features of the present invention in prescribed forms. And, it may be able to consider that the respective elements or features may be selective unless they are explicitly mentioned. Each of the elements or features may be implemented in a form failing to be combined with other elements or features. Moreover, it may be able to implement an embodiment of the present invention by combining elements and/or features together in part. A sequence of operations explained for each embodiment of the present invention may be modified. Some configurations or features of one embodiment may be included in another embodiment or can be substituted for corresponding configurations or features of another embodiment.

Specific terminologies used in the following description are provided to help the understanding of the present invention and can be modified to a different form in a scope of not deviating from the technical idea of the present invention.

Occasionally, to prevent the present invention from getting vaguer, structures and/or devices known to the public are skipped or can be represented as block diagrams centering on the core functions of the structures and/or devices. Wherever possible, the same reference numbers will be used throughout the drawings to refer to the same or like parts.

Embodiments of the present invention can be supported by the standard documents disclosed in at least one of IEEE (Institute of Electrical and Electronics Engineers) 802 system, a 3GPP system, 3GPP LTE/LTE-A (LTE-Advanced), and a 3GPP2 system, which correspond to wireless access systems. In particular, steps or parts among the embodiments of the present invention, which are not explained to clearly disclose the technical idea of the present invention, can be supported by the documents. And, all terminologies disclosed in the present specification can be explained by the standard document.

The following description of embodiments of the present invention may apply to various wireless access systems. For clarity, the following description mainly concerns 3GPP LTE system or 3GPP LTE-A system, by which the technical idea of the present invention may be non-limited.

Terminologies used in the present specification can be defined as follows.
UMTS (Universal Mobile Telecommunications System): a GSM (Global System for Mobile Communication)-based 3^{rd} generation mobile communication technology developed by 3GPP.
EPS (Evolved Packet System): a network system consisting of such an access network as an EPC (Evolved Packet Core) corresponding to an IP-based packet switched core network, LTE, UTRAN, and the like. The EPS is a network of an evolved version of the UMTS.
PLMN (Public Land Mobile Network): a network configured for the purpose of providing a mobile communication service to personnel. The PLMN can be configured according to an operator.
UE (user equipment): a user device. The UE may be mentioned with such a terminology as a terminal, an ME (Mobile Equipment), an MS (Mobile Station), and the like. And, the UE may correspond to such a device capable of being carried as a notebook, a cellular phone, a PDA (Personal Digital Assistant), a smartphone, a multimedia device, and the like or such a device not capable of being carried as a PC (Personal computer), a vehicle-mounted device.
Node B: a base station of GERAN/UTRAN. The Node B is installed outdoors and coverage of the Node B corresponds to a size of a macro cell.
eNode B: a base station of LTE. The eNode B is installed outdoors and coverage of the eNode B corresponds to a size of a macro cell.
HNB (Home Node B): a CPE (Customer Premises Equipment) providing UTRAN (UMTS Terrestrial Radio Access Network) coverage. Refer to standard document TS 25.467 for more details.
HeNB (Home eNode B): a CPE (Customer Premises Equipment) providing E-UTRAN (Evolved-UTRAN) coverage. Refer to standard document TS 36.300 for more details.
RAN (Radio Access Network): a unit including a Node B, an eNode B, and an RNC (Radio Network Controller) controlling the Node B and the eNode B in 3GPP network. The RAN exists between a UE and a core network and provides a connection to the core network.
RANAP (RAN Application Part): an interface between RAN and a node (MME (Mobility Management Entity)/SGSN (Serving GPRS (General Packet Radio Service)/MSC (Mobiles Switching Center)) in charge of a control of a core network.
MME (Mobility Management Entity): a network node of an EPS network performing a function of mobility management, session management, and the like.
PDN-GW (Packet Data Network Gateway): a network node of an EPS network performing a function of assigning UE IP address, packet screening and filtering, collecting charging data, and the like.
Serving-GW (Serving Gateway): a network node of an EPS network performing a function of mobility anchor, packet routing, idle mode packet buffering, triggering MME to page a UE.
PCRF (Policy and Charging Rule Function): a network node of an EPS network performing a policy decision to dynamically apply QoS differentiated according to a service flow and a charging policy.
PDN (Packet Data Network): a network at which a server (e.g., MMS (Multimedia Messaging Service) server, WAP (Wireless Application Protocol) server) supporting a specific service is located.
PDN connection: a connection from a UE to PDN. The PDN connection means a relation (or connection) between a user equipment represented by an IP address and a PDN represented by APN.
APN (Access Point Name): a string configured to indicate or identify a PDN. In order to access a requested service or a network (PDN), it is necessary to undergo a corresponding P-GW. The APN means a name (string) predetermined within the network to find out the P-GW (e.g., internet.mnc012.mcc345.gprs).
HLR (Home Location Register)/HSS (Home Subscriber Server): a database including subscriber information within a 3GPP network. HSS can perform such a function as configuration storage, identity management, user state storage, and the like.
ePDG (enhanced Packet Data Gateway): a network node used for routing data, which access 3GPP via an untrusted non-3GPP access (e.g., WiFi). The ePDG forms an IPsec (Internet Protocol Security) tunnel with UE.
3GPP AAA (Authentication, Authorization and Accounting) server: a network node performing authentication for a 3GPP subscriber UE accessing 3GPP via a non-3GPP access.
RG (Residential Gateway): a gateway located at a home network of a user defined in BBF (Broadband Forum) and used for going out to an external network.
BNG (Broadband Network Gateway): a gateway located at a fixed broadband access network defined in BBF.
BPCF (BBF Policy Control Function): a node in charge of determining a policy in a fixed broadband access network defined in BBF. The BPCF is a node corresponding to PCRF in 3GPP.
DSCP (Differentiated Service Code Point): a field of an IP packet enabling services in which levels are different from each other to be allocated to network traffic.
reflective QoS: a method of managing QoS in a manner of making a DSCP marking rule based on a downlink traffic packet and setting a corresponding DSCP value to an IP header of uplink traffic.

Following description is explained based on the terminologies defined in the above.

EPC (Evolved Packet Core)

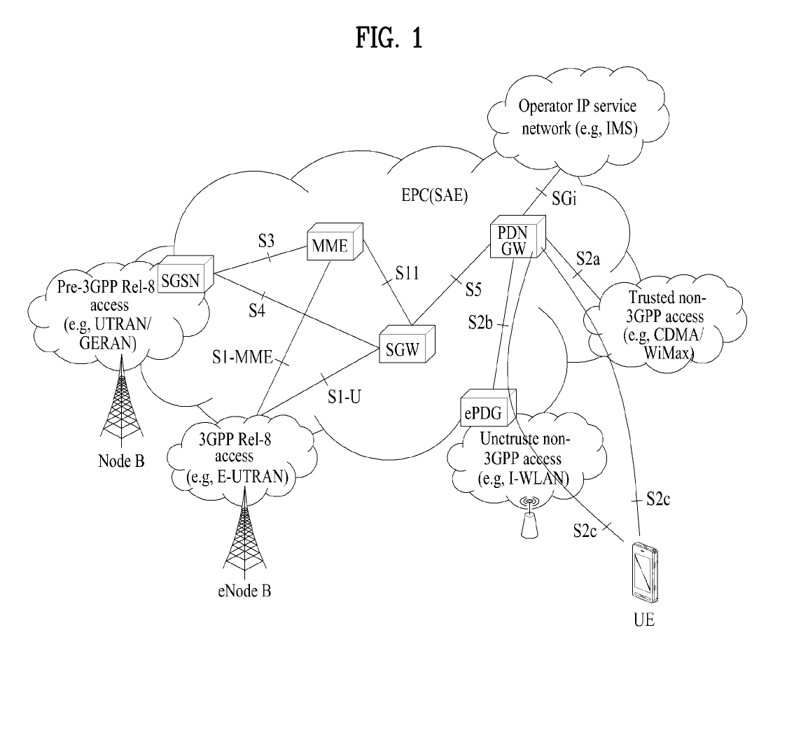

FIG. 1 is a schematic diagram for a structure of an EPS (evolved packet system) including an EPC (evolved packet core).

The EPC is a core element of SAE (system architecture evolution) to enhance performance of 3GPP technologies. The SAE corresponds to a subject of research to determine a network structure supporting mobility between various kinds of networks. For instance, an object of the SAE is to provide an optimized packet-based system configured to support IP-based various wireless access technologies and configured to provide more enhanced data transmission capability.

Specifically, the EPC is a core network of an IP mobile communication system for 3GPP LTE system and may support a packet-based real time and non-real time service. In a legacy mobile communication system (i.e., 2^{nd} generation or 3^{rd} generation mobile communication system), a function of a core network is implemented by two distinguished sub-domains, i.e., CS (circuit-switched) for audio and PS (packet-switched) for data. Yet, in 3GPP LTE system corresponding to an evolved version of a 3^{rd} generation mobile communication system, the sub-domains including the CS and the PS are unified into a single IP domain. In particular, in the 3GPP LTE system, establishment of a connection between UEs equipped with IP capability can be configured via an IP-based base station (e.g., eNode B (evolved Node B)), EPC, an application domain (e.g., IMS (IP multimedia subsystem)). In particular, the EPC is an essential structure necessary for implementing an end-to-end IP service.

The EPC can include various configuration elements. FIG. 1 shows a part of the various configuration elements including a SGW (serving gateway), a PDN GW (packet data network gateway), an MME (mobility management entity), an SGSN (serving GPRS (general packet radio service) supporting node), an ePDG (enhanced packet data gateway).

The SGW is an element operating as a boundary point between a radio access network (RAN) and a core network and performing a function of maintaining a data path between an eNode B and a PDN GW. And, if a UE moves according to a region served by the eNode B, the SGW plays a role of a local mobile anchor point. In particular, packets can be routed via the SGW for mobility in E-UTRAN (Evolved-UMTS (universal mobile telecommunications system) terrestrial radio access network, which is defined after 3GPP release-8). And, the SGW may function as an anchor point for mobility with a different 3GPP network (a RAN (radio access network), which is defined prior to 3GPP release-8, e.g., UTRAN or GERAN (GSM (global system for mobile communication)/EDGE (enhanced data rates for global evolution).

The PDN GW (or P-GW) corresponds to a termination point of a data interface heading to a packet data network. The PDN GW may support policy enforcement features, packet filtering, charging support, and the like. And, the PDN GW may play a role of an anchor point for mobility management with a 3GPP network and a non-3GPP network (e.g., such an untrusted network as an I-WLAN (interworking wireless local area network) and such a trusted network as a CDMA (code division multiple access) network and WiMAX).

Although an example of a network structure depicted in FIG. 1 shows that the SGW and the PDN GW are configured with gateways different from each other, two gateways may be implemented according to a single gateway configuration option.

The MME is an element performing signaling and control functions configured to support an access of a UE for a network connection, allocation of a network resource, tracking, paging, roaming, handover, and the like. The MME controls control plane functions related to a subscriber and session management. The MME manages many eNode Bs and performs signaling to select a legacy gateway to make a handover to a different 2G/3G network. And, the MME performs functions including security procedures, terminal-to-network session handling, idle terminal location management, and the like.

The SGSN handles all packet data such as mobility management and authentication for a different 3GPP network (e.g., GPRS network) of a user.

The ePDG plays a role of a security node for an untrusted non-3GPP network (e.g., I-WLAN, WiFi hot spot, and the like).

As mentioned in the foregoing description with reference to FIG. 1, a UE equipped with an IP capability can access an IP service network (e.g., IMS) provided by a service provider (i.e., operator) via various elements within the EPC based on a non-3GPP access as well as a 3GPP access.

And, FIG. 1 shows various reference points (e.g., S1-U, S1-MME, and the like). In 3GPP system, a conceptual link linking 2 functions, which exist in different functional entities of E-UTRAN and EPC, is defined as a reference point. Table 1 in the following is a summary of the reference points depicted in FIG. 1. Various reference points may exist in accordance with a network structure except the examples of Table 1.

TABLE 1

| Reference | |
|---|---|
| point | description |
| S1-MME | Reference point for the control plane protocol between E-UTRAN and |
| | MME |
| S1-U | Reference point between E-UTRAN and Serving GW for the per bearer |
| | user plane tunneling and inter e NodeB path switching during handover |
| S3 | It enables user and bearer information exchange for inter 3GPP access |
| | network mobility in idle and/or active state. This reference point can be |
| | used intra-PLMN or inter-PLMN (e.g. in the case of Inter-PLMN HO). |
| S4 | It provides related control and mobility support between GPRS Core and |
| | the 3GPP Anchor function of Serving GW. In addition, if Direct Tunnel |
| | is not established, it provides the user plane tunneling. |
| S5 | It provides user plane tunneling and tunnel management between Serving |
| | GW and PDN GW. It is used for Serving GW relocation due to UE |
| | mobility and if the Serving GW needs to connect to a non-collocated |
| | PDN GW for the required PDN connectivity. |
| S11 | Reference point between MME and Serving GW |
| SGi | It is the reference point between the PDN GW and the packet data |
| | network. Packet data network may be an operator external public or |
| | private packet data network or an intra-operator packet data network, e.g. |
| | for provision of IMS services. This reference point corresponds to Gi for |
| | 3GPP accesses. |

Among the reference points depicted in FIG. 1, an S2a and an S2b correspond to a non-3GPP interface. The S2a is a reference point providing a relevant control and mobility support between a trusted non-3GPP access and the PDN GW to a user plane. The S2b is a reference point providing a relevant control and mobility support between the ePDG and the PDN GW to the user plane. An S2c is a reference point between a UE and the P-GW.

As mentioned in the foregoing description, besides a GTP (GPRS Tunneling Protocol), which is conventionally used in a legacy 3GPP, various protocols of IETF (internet engineering task force) are introduced while non-3GPP interworking is supported. In particular, such IETF protocols as PMIPv6 (proxy mobile IPv6), DSMIPv6 (dual stack mobile IPv6), and the like are introduced in a draft version state previous of RFC (request for comments) of the IETF and are currently used as an important protocol of the non-3GPP interworking in SAE standard. Basically, a GTP protocol is used for 3GPP inter-radio access technology handover and IETF-based protocols are used for S2 interfaces to perform the non-3GPP interworking. In particular, an S5, which is a reference point providing user plane tunneling and tunnel management between the S-GW and the P-GW, and an S8 (not depicted), which is a reference point used in case of roaming, can support both the GTP and the IETF-based protocol. Table 2 in the following shows protocol options usable for several important reference points of an SAE structure on the basis of release-8 system.

TABLE 2

| Reference | | |
|---|---|---|
| point | Use section | Available protocol |
| S1-U | E-UTRAN~SGW | GTP-U |
| S3 | SGSN~MME | GTP |
| S4 | SGSN~SGW | GTP |
| S5 | SGW~P_GW | GTP, PMIP |
| S8 | inter-PLMN of S5 | GTP, PMIP |
| | (roaming) | |
| S2a | trusted non-3GPP IP | PMIPv6, |
| | access~P-GW | CMIPv4(Client Mobile IPv4) |
| | | FA(Foreign Agent) CoA(Care of |
| | | Address) mode, DSMIPv6 |
| S2b | ePDG~P-GW | PMIPv6 |
| S2c | UE~P-GW | DSMIPv6 |

Non-3GPP Access Network Support in EPS

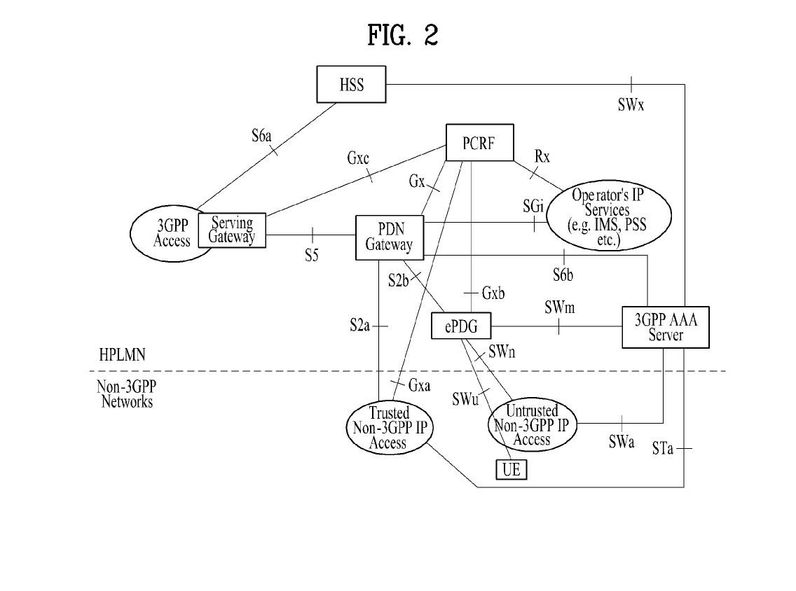

FIG. 2 is a diagram for one of EPS structures supporting a non-3GPP access. An example of FIG. 2 corresponds to a non-roaming structure using S5, S2a, and S2b within the EPS. In the example of FIG. 2, non-3GPP networks can be connected with nodes of HPLMN (Home-PLMN). For instance, a trusted non-3GPP IP access can be connected with the P-GW via the S2a and an untrusted non-3GPP IP access can be connected with the P-GW via the S2b by way of the ePDG. For more detailed explanation on the network nodes and reference point depicted in FIG. 2, refer to standard document TS 23.402. FIG. 2 shows an HSS and a PCRF (policy and charging rules function) entity not depicted in FIG. 1. The HSS is a database including subscriber information within a 3GPP network and the PCRF is an entity used for controlling a 3GPP network policy and service quality (QoS). A 3GPP AAA server is a network node, which performs authentication for a 3GPP subscriber UE configured to access via a non-3GPP access.

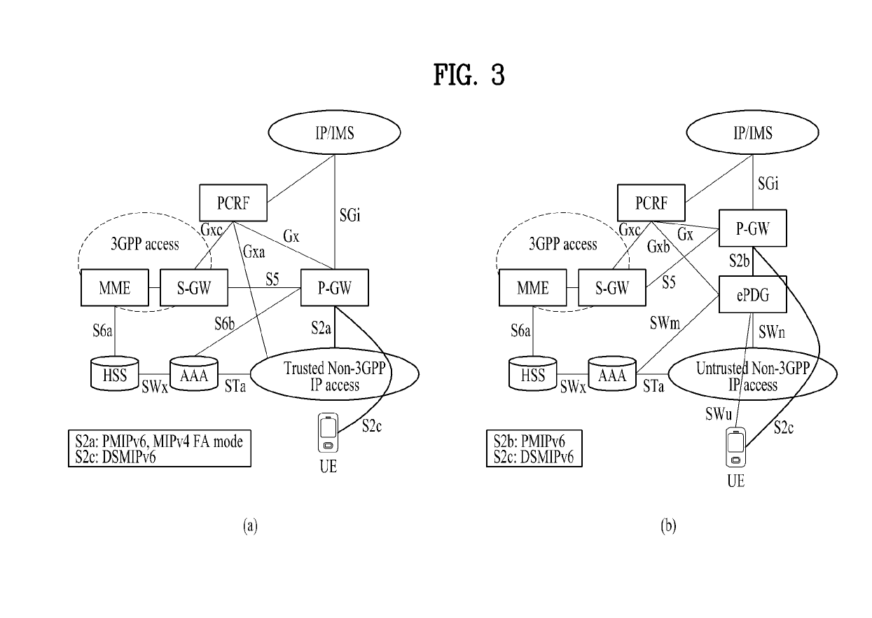

FIG. 3 is a diagram for an EPS structure supporting a non-3GPP access network depicted in detail for a case of a trusted non-3GPP access network and a case of an untrusted non-3GPP access network. FIG. 3 (a) is an example for the trusted non-3PP access network and FIG. 3 (b) is an example for the untrusted non-3PP access network.

As a representative example of the non-3GPP access network, WLAN can be supported in 3GPP EPS. The WLAN can be named an interworking-WLAN. The 3GPP EPS can mainly classify the non-3GPP access network into a trusted non-3GPP access and an untrusted non-3GPP access. The trusted non-3GPP access indicates an access network capable of trusting a security mechanism of the non-3GPP access network itself in terms of a service provider. A representative example of the trusted non-3GPP access corresponds to a HRPD (high rate packet data) network, WiMAX, or the like. Meanwhile, the untrusted non-3GPP access means an access network classified for the purpose of supplementing the security mechanism with IPsec, IKEv2 (internet key exchange version 2) and the like since the security mechanism of the non-3GPP access network is not trusted in terms of the service provider. To this end, as depicted in FIG. 3 (b), an interface between the ePDG and the UE is defined by a reference point SWu supporting the IPsec.

Meanwhile, in terms of a mobility management protocol capable of being used in release-8 EPS, a network-based protocol and a UE-based protocol can be used for the WLAN interworking corresponding to the untrusted non-3GPP access network. For instance, the network-based protocol corresponds to PMIPv6 via the S2c (PMIPv6-via-S2 c) and the UE-based protocol corresponds to DSMIPv6 via the S2c (DSMIPv6-via-S2 c).

Specifically, as depicted in FIG. 3 (a) and FIG. 3 (b), the P-GW plays a role of an anchor point for interworking with the non-3GPP access network. In this case, a protocol capable of being used as an S2b interface between the ePDG and the P-GW is PMIPv6 corresponding to a representative example of the network-based protocol. As a different method, seamless handover and mobility can be supported in a manner of using an S2c interface between the UE and the P-GW, which is used irrespective of a type of the access network, i.e., DSMIPv6. A standard document TS 23.402 describing on a resource of the non-3GPP access network respectively defines a process of an initial access and a process of establishing a connection with the PDN for the aforementioned two methods and defines a handover procedure between a legacy 3GPP access network (i.e., UTRAN/GERAN) and the untrusted non-3GPP access network (WLAN) as well as between E-UTRAN and the untrusted non-3GPP access network.

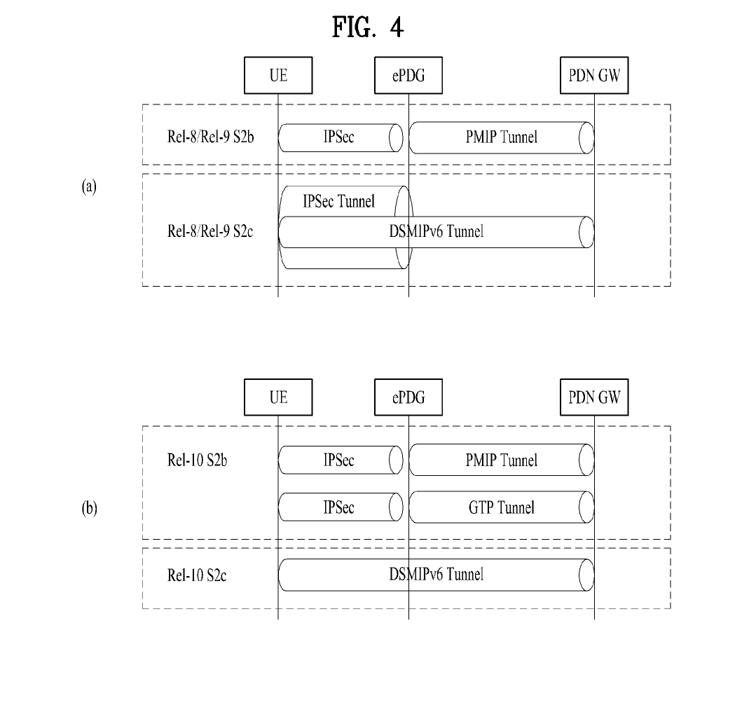

FIG. 4 is a diagram for explaining a protocol used for a non-3GPP access network. FIG. 4 (a) indicates a protocol used in an S2b and S2c of a release-8 or a release-9 system. FIG. 4 (b) indicates a protocol used in an S2b and S2c of a release-10 system.

The S2b interface basically uses PMIPv6 in the EPS structure of release-8 or 9 system. Yet, in release-10 system, a GTP, which has been conventionally used in 3GPP, is included in the S2b interface in order for a service provider to increase flexibility for a network configuration and reduce burden of managing/operating two types of protocols (GTP/PMIP) in some cases. In other word, in the release-10 EPS structure, interworking with the non-3GPP access network is enabled by the GTP protocol only. This technique is called SMOG (S2b Mobility based on GTP) and is finally reflected to a standard document TS 23.402 release-10 version after passing through TR 23.834.

And, the release-10 system has introduced user plane encryption for the S2c interface. Although an operation of differently using DSMIPv6 in accordance with the trusted or the untrusted non-3GPP access network has an important meaning in release-8 system, the importance is diluted as the additional user plane encryption is introduced in the release-10 system. In particular, since the encryption protocol is additionally provided for the untrusted access network in addition to the DSMIPv6-via-S2c using the SWu interface (IPsec/IKEv2) together, it may be not mandatory to use the DSMIPv6-via-S2c. Consequently, it is able to use at least one selected from the group consisting of PMIP-via-S2b (together with IPsec/IKEv2-via-SWu), GTP-via-S2b (together with IPsec/IKEv2 via SWu), and DSMIPv6-via-S2c (together with user plane encryption) to access WLAN in the release-10 system.

3GPP System and Fixed Broadband Access Network Interworking

In case of interworking a 3GPP system and a fixed (or wired) broadband access network, a reference model for a scenario using WLAN and a reference model for a scenario using a femto cell are defined and a discussion on mobility, authentication, charging, QoS, and the like is in progress. And, a discussion on a network structure, a service provider policy, charging, QoS for interworking with a broadband access network is in progress based on 3GPP release-10 system. This is called a BBAI (broadband access interworking) or BBF (broadband forum) interworking technology.

Prior to the detailed explanation on the BBF interworking technology, general explanation on the femto cell is described in the following.

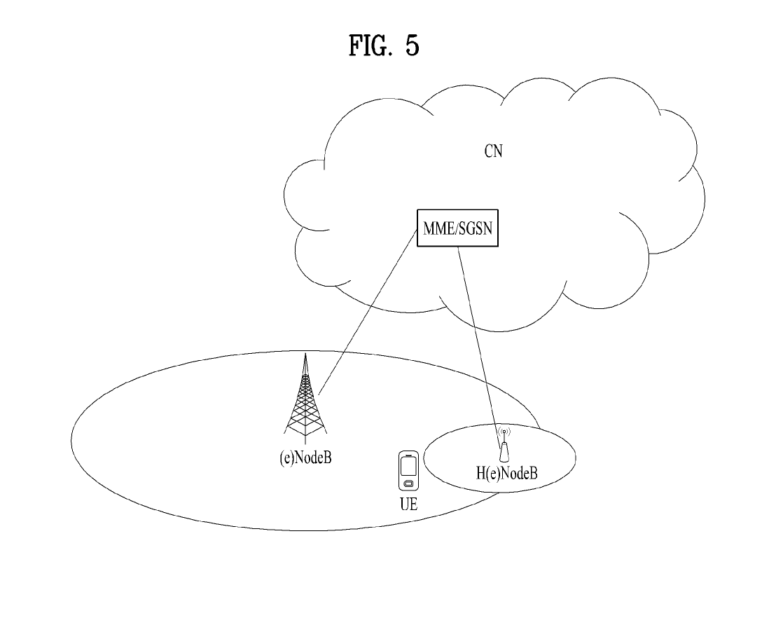

FIG. 5 is a diagram for an (e)Node B and a H(e) Node B. The (e)NB may correspond to a base station managing a macro cell and the H(e)Node B may correspond to a base station managing a micro cell. The macro cell can provide wide coverage with high transmit power. The micro cell can provide narrow coverage with the transmit power lower than that of the macro cell. The micro cell can be called a pico cell, a femto cell, or the like. For instance, the micro cell can be installed in a radio shadow area not capable of being covered by the macro cell. A user can access a local network, the public internet, a network providing a private service, and the like via the micro cell. And, the micro cell can be classified according to whether an access of a user is limited. A first type of the micro cell is a closed subscriber group (hereinafter abbreviated CSG) and a second type of the micro cell is an open access (OA) or an open subscriber group (hereinafter abbreviated OSG). The CSG micro cell is accessed by permitted specific users only. The OSG micro cell is accessed by all users without any restriction. In addition, in case of a micro cell of a hybrid access type, a user possessing a CSG ID can be provided with a CSG service. Meanwhile, a subscriber not belonging to the CSG is permitted to access but the CSG service may not be provided to the subscriber.

Although FIG. 5 representatively shows MME or SGSN only in a core network (CN) in an example, the core network can further include such a network node as S-GW, P-GW, PCRF, HSS, ePDG, 3GPP AAA server, and the like.

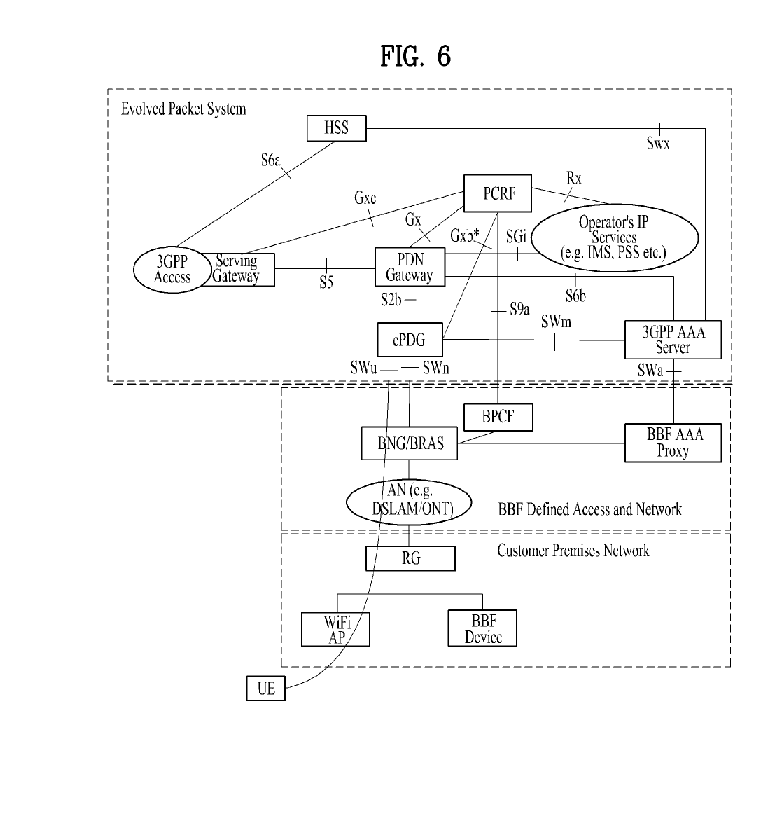

FIG. 6 to FIG. 8 is a diagram for a BBF interworking network reference model.

Referring to FIG. 6 to FIG. 8, the EPS is mentioned earlier with reference to FIG. 1 and FIG. 2 and an access and network (i.e., BBF access network) defined by the BBF play a role of a backhaul network connecting a home network and the EPS. A CPN (customer premises network) corresponds to a home network of a user.

FIG. 6 shows a network structure including a BBF interworking traffic path using WLAN. An example of FIG. 6 corresponds to a non-roaming structure for an untrusted fixed broadband access network based on an S2b. In the example of FIG. 6, user traffic can be delivered to AN (access node) of a BBF access network from a home network in a manner of passing through a WiFi AP (access point) and an RG. The AN (access node) of the BBF access network corresponds to a DSLAM (digital subscriber line access multiplexer) or ONT (optical network termination). The user traffic received by the AN of the BBF access network can be delivered to a core network (e.g., ePDG) via BNG/BRAS (broadband remote access server). The user traffic can be delivered to a service provider service network via the P-GW and the like in the core network.

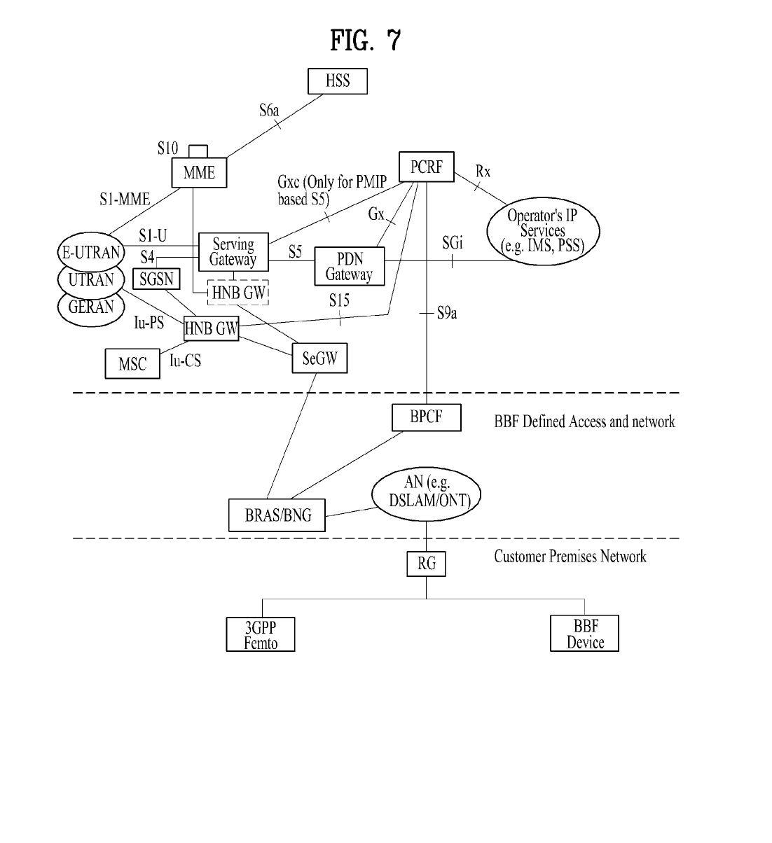

FIG. 7 shows a network structure including a BBF interworking traffic path in case of using a femto cell. An example of FIG. 7 corresponds to a non-roaming structure based on an S2b. In the example of FIG. 7, user traffic can be delivered to AN of a BBF access network from a home network in a manner of passing through a 3GPP femto cell (i.e., H(e)NB) and an RG. The user traffic received by the AN of the BBF access network can be delivered to a core network via BNG/BRAS. In the BBF interworking traffic path using the 3GPP femto cell, the user traffic can be delivered to the SGW via a SeGW (security gateway) of the core network and can be delivered to the service provider service network via the P-GW and the like.

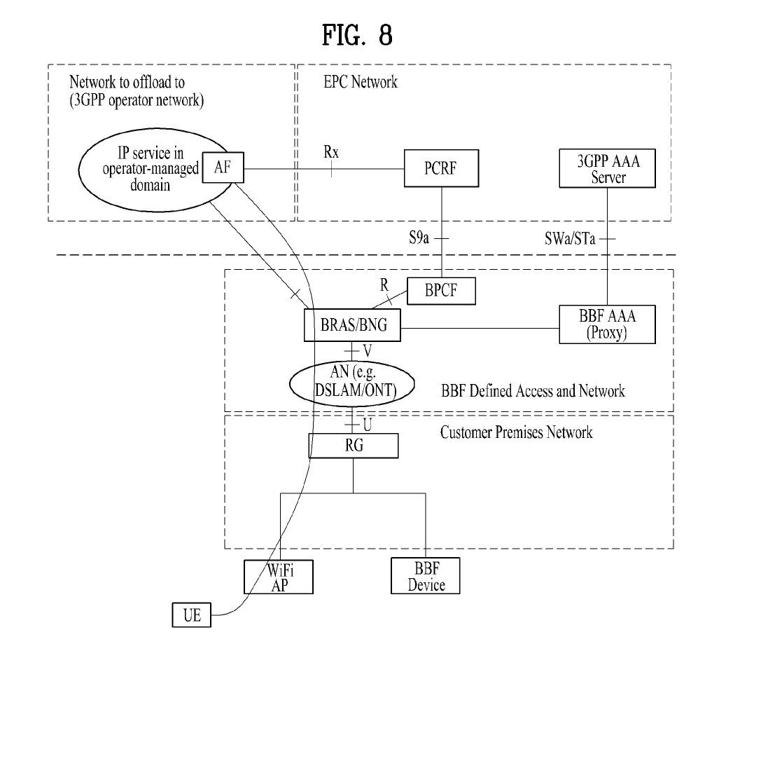

FIG. 8 shows a network structure including a BBF interworking traffic path in case of offloading via WLAN. An example of FIG. 8 corresponds to a non-roaming structure for NSWO (non-seamless WLAN offload) in a 3GPP domain.

In case of an interworking network scenario using WLAN, besides a path mandatorily passing through a core network of a mobile communication service provider, i.e., EPC-routed traffic path (in case of FIG. 6), a path which is offloaded via the WLAN without passing through the core network of the mobile communication service provider, i.e., a WLAN offload traffic path may be used. In this case, WLAN offloading may not support seamless offloading (i.e., may include non-seamless offload). In the example of FIG. 8, user traffic can be delivered to AN of a BBF access network from a home network in a manner of passing through a WiFi AP and an RG. The user traffic received by the AN of the BBF access network can be delivered to an AF (application function) entity of a service provider service network via BNG/BRAS. (In particular, it is different from the example of FIG. 6 in that the user traffic is delivered to the core network (e.g., ePDG) via the BNG/BRAS).

As depicted in FIG. 6 to FIG. 8, an S9a is newly defined as an interface to establish a connection between the 3GPP network and the broadband network. The S9a interface is in charge of delivering a dynamic QoS control policy and a local IP address (a local IP address of a UE or a femto system) between BPCF (policy control rule function) corresponding to a service provider policy control node of the broadband network and PCRF (policy control rule function) corresponding to a 3GPP service provider policy control node. A unified service provider policy and QoS interworking can be achieved between two systems based on the information.

For more detail information on the BBF interworking network structure explained earlier with reference to FIG. 6 to FIG. 8, refer to a standard document TS 23.139 and TS 23.203.

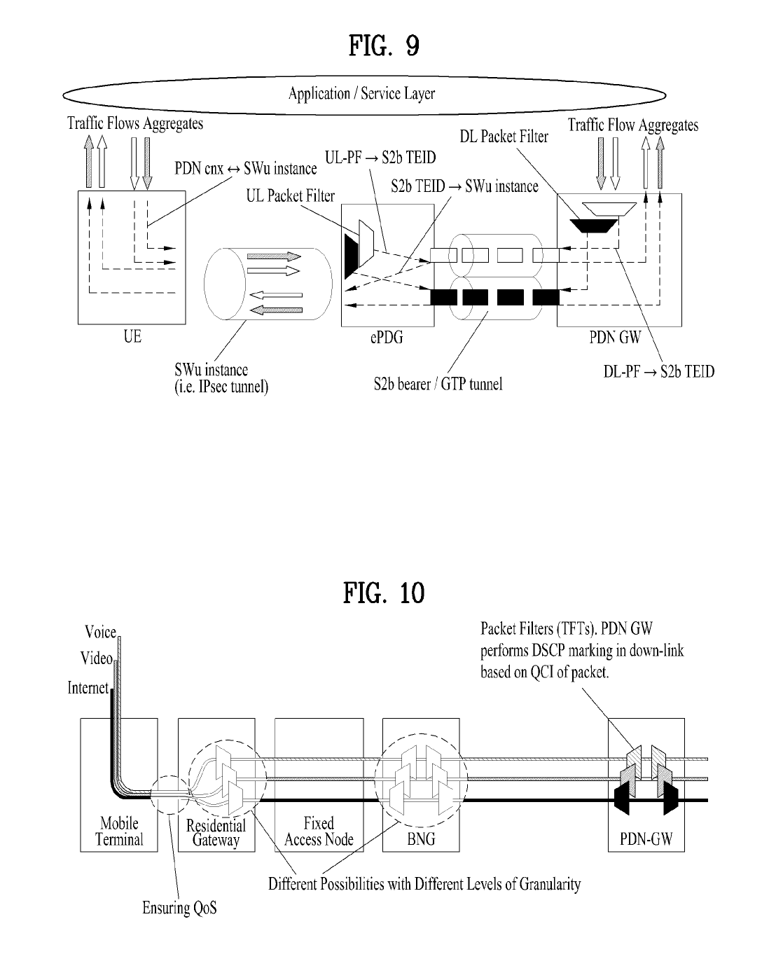

FIG. 9 is a diagram for explaining an S2b bearer.

An example of FIG. 9 shows a case that a UE establishes a connection with a 3GPP PDN GW via an ePDG. One IPsec tunnel per PDN connection is formed between the UE and the ePDG and an S2b is formed between the ePDG and the PDN-GW. A GTP tunnel or a PMIP tunnel can be generated depending on a protocol used by the S2b bearer. FIG. 9 shows an example of GTP-based unicast S2b bearers (i.e., an example of generating a GTP tunnel).

According to a conventional method stopping by 3GPP LTE, a UE performs appropriate mapping for a radio bearer (i.e. a radio section between the UE and (e)NB) using a UL-TFT (uplink traffic filter template). Yet, in case of a non-3GPP access depicted in the example of FIG. 9, the ePDG performs UL packet filtering. The UL packet filtering may include a process of mapping an output of a UL packet filter to an appropriate S2b TEID (tunnel endpoint ID). In case of UL traffic, the UE delivers a data packet to the ePDG via one IPsec tunnel. And, the ePDG selects a corresponding S2b bearer by the UL packet filter and delivers the UL traffic to the PDN GW via the selected bearer.

In case of DL traffic, the PDN GW selects a corresponding S2b bearer by a DL packet filter and delivers the DL traffic to the ePDG via the selected bearer. The ePDG delivers the DL traffic to the UE via one IPsec tunnel. The DL packet filtering may include a process of mapping an output of the UL packet filter to an appropriate S2b TEID.

Information on the UL/DL-TFT is delivered to the UE, the ePDG, the PDN GW, and the like based on subscriber information or information (i.e., information on a policy and charging of a service provider) from the PCRF when a bearer is configured according to a type of the bearer. For more details on the S2b bearer explained with reference to FIG. 9, refer to a standard document TS 23.402.

FIG. 10 is a diagram for explaining a packet classification and a packet forwarding operation in an interworking scenario of a 3GPP system and a fixed broadband system. An example depicted in FIG. 10 shows a case that a UE establishes a connection with 3GPP PDN GW via BBF access network. Among the operations of the S2b bearer depicted in FIG. 9, FIG. 10 particularly shows an operation of performing a treatment for QoS. In particular, although the ePDG practically exists between the BNG and the PDN GW, the ePDG is not depicted in FIG. 10. And, an IPsec tunnel is generated between the UE and the ePDG and a PMIP or a GTP tunnel can be generated between the ePDG and the PDN GW.

In the example of FIG. 10, the UE classifies a type (an audio, a video, the internet, etc.) of UL traffic and may be then able to provide it to an RG. QoS for the UL traffic can be processed by the RG. The RG filters the UL traffic and can deliver the filtered UL traffic to the BNG via the fixed broadband access node. The BNG also filters the UL traffic and can provide the filtered UL traffic to the PDN-GW via the ePDG. In this case, filtering in the RG and filtering in the BNG may have an identical level of granularity or may have granularity levels different from each other.

Meanwhile, in case of DL, the PDN GW may perform packet filtering and processing for QoS. For instance, the PDN GW can perform DSCP (differentiated service code point) marking for a DL packet based on a QoS parameter (e.g., QCI (QoS class ID)).

For more details on the packet classification and the packet forwarding explained with reference to FIG. 10, refer to a standard document TS 23.139.

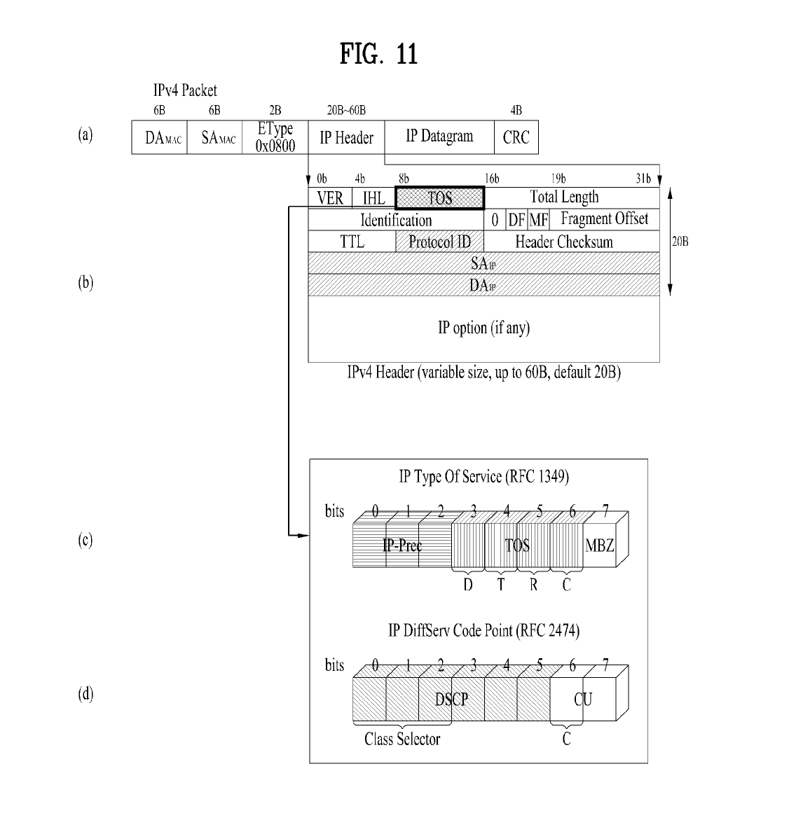

FIG. 11 is a diagram for explaining a DSCP (differentiated service code point).

FIG. 11 (a) shows a structure of an IPv4 packet. The IPv4 packet includes a DA_{MAC} ((destination address)_MAC (medium access control) address) field, an SA_{MAC} ((source address_MAC address) field, an Etype (Ether type) field (mostly configured by 0×0800 value), an IP Header field, an IP Datagram field, and a CRC (cyclic redundancy check) field.

FIG. 11 (b) shows a specific configuration for the IP Header field of the IPv4 packet shown in FIG. 11 (a). The IP Header field includes a VER (version) field, an IHL (internet header length) field, a TOS (type of service) field, a Total Length field, an Identification field, a Flag field (consisting of subfields including 0, DF (Don't fragment), and MF (more fragment)), a Fragment Offset field, a TTL (time to live) field, a Protocol ID field, a Header Checksum field, an SA_{IP} (source address_IP address) field, a DA_{IP} (destination address_IP address) field, and an option (including padding) field.

FIG. 11 (c) shows a configuration of a TOS field. The TOS field includes an IP-precedence field (indicating precedence of 8 levels), a TOS (consisting of D, T, R, and C field) field, and an MBZ (must be zero) field. In the TOS field, the D (delay) field indicates that a short delay or a long delay is required, the T (throughput) field indicates that a low throughput or a high throughput is required, the R (reliability) field indicates that a low reliability or a high reliability is required, the C (cost) field indicates whether a route providing a low cost is requested, and a U (unused) field corresponds to a unused or a reserved field. For more details, refer to IETF RFC 1349.

In this case, the TOS field of the IP Header depicted in FIG. 11 (b) can be replaced with a DSCP field of FIG. 11 (d). The DSCP field depicted in FIG. 11 (d) consists of a DSCP subfield of 6-bit and a CU subfield of 2-bit. The DSCP subfield can indicate 64 (2⁶) kinds of classes for a method of processing a packet. In this case, upper 3 bits are used as a CS (class selector) and defined to be used in a manner of being compatible with a legacy precedence value. It may be comprehended that a relative priority is higher as a value of the CS is higher. A node configured to process an IP packet can select a method of processing the packet depending on a scheme indicated by the DSCP field. For more details, refer to IETF RFC 2474.

Securing QoS in Case of Interworking 3GPP System and Fixed Broadband Access Network

A method of securing QoS in case of applying interworking (i.e., BBF interworking) of 3GPP system and a fixed broadband access network is explained based on the description described earlier with reference to FIG. 10 and FIG. 11. In order to secure QoS in case of the BBF interworking, a traffic classification mechanism can be used as follows.

First of all, a method of securing QoS for DL data is explained. The DL data from an external network comes into the PDN-GW of 3GPP network. According to a legacy 3GPP system, if a dynamic policy is performed, the PDN-GW performs traffic filtering for the DL data and mapping to an appropriate bearer according to PCC (policy and charging control)/QoS rule received from the PCRF. Similarly, in the BBF interworking structure, the PDN-GW performs an operation similar to the operation performed in the legacy 3GPP system. In addition, BPCF can obtain the PCC/QoS rule from the 3GPP PCRF via an S9a interface, generate a packet classification rule comprehensible by the fixed broadband network based on the PCC/QoS rule, and may be then able to convert the packet classification rule to a parameter form comprehensible by such a BBF access network as BNG and the like. Having received the PCC/QoS rule, which is converted by the BPCF, used for the BBF access network, the BNG performs policy enforcement for the DL data received via the PDN-GW/ePDG based on the PCC/QoS rule used for the BBF access network.

Meanwhile, in case of UL data, a UE can directly perform packet classification.

According to one example, a packet classification rule can be generated by an application of the UE.

According to a different example, a packet classification rule can be applied or generated in a manner of applying a reflective QoS. The reflective QoS corresponds to a scheme of determining QoS for the UL data with reference to the DL data received by the UE. Specifically, the UE generates a DSCP rule, which applies a QoS level of an identical level, based on firstly received DL traffic (e.g., a scheme of copying a DL QoS level) and may operate in a manner of setting a corresponding DSCP value to an IP header of UL traffic which is intended to be transmitted. In particular, the reflective QoS is a scheme of transmitting the UL data in a manner of forming the UL data to have a level identical to the QoS level of the received DL data. If this sort of UL data is delivered to the ePDG of the 3GPP network, the UL data is mapped to an appropriate S2b bearer by a 3GPP UL packet filter and can be transmitted to an external PDN via the PDN GW.

In this case, in order to apply the reflective QoS, a UE should be equipped with a capability capable of performing a corresponding function. Yet, according to a legacy system, whether the UE is equipped with the reflective QoS capability is defined as an optional item. In particular, the UE may or may not be equipped with the reflective QoS capability.

And, according to the legacy system (e.g., refer to standard document TS 23.139 v1.1.0), it is defined that a network determines whether to apply the reflective QoS to a 3GPP UE and the network informs the UE of a decision on whether the reflective QoS is applied in case that the UE attaches to the network. According to the legacy system, although the reflective QoS is applied to a UE supporting the reflective QoS by the indication of the network, a UE not supporting the reflective QoS ignores the indication of the network.

Improved Method of Securing UL QoS

According to a legacy system, it is defined that a network has a decision-making authority on whether to apply the reflective QoS and it is not determined that a notification on whether a UE is equipped with a capability of supporting the reflective QoS is performed or not. Hence, in case of determining whether to apply a network reflective QoS in the legacy system, it is unable to consider whether the UE is equipped with the capability of supporting the reflective QoS. In other word, according to the legacy system, the network should determine whether to apply the reflective QoS for the UE without considering whether the reflective QoS is supported by the UE.

As mentioned in the foregoing description, since the network is unable to know whether the UE supports the reflective QoS in the legacy system, it is inefficient to limit for the network to determine whether to apply the reflective QoS to the UE. For instance, although the network determines or indicates the reflective QoS to be applied to the UE, if the UE does not support the reflective QoS, the reflective QoS cannot be applied. In this case, the indication of the network indicating the application of the reflective QoS becomes unnecessary. Or, if the network determines or indicates that there is no reflective QoS application in the UE, a reflective QoS operation cannot be performed despite the UE has capability of supporting the reflective QoS. In this case, the indication of the network indicating not to apply the reflective QoS becomes inefficient.

Since the capability of the UE corresponds to information already known to the UE, it is more efficient for the UE to make a request for whether to apply the reflective QoS to the network in a manner of providing the information to the network or to determine whether to apply the reflective QoS by the UE itself. By doing so, it would prevent the network from making an unnecessary or wrong operation. In consideration of this, the present invention proposes a new scheme of efficiently securing UL QoS of the UE in case of interworking (i.e., BBF interworking) of 3GPP system and the fixed broadband access network.

A first scheme relates to a scheme of informing a network of whether a UE supports reflective QoS.

As a scheme 1-1, when a UE attaches to a network, information on whether the UE is equipped with capability of supporting the reflective QoS can be provided to the network. In this case, the UE can indicate whether the UE is equipped with the capability of supporting the reflective QoS to a network node in the course of an authentication process. Or, the UE can indicate whether the UE is equipped with the capability of supporting the reflective QoS to the network node in the course of IKEv2 tunnel establishment process.

As a scheme 1-2, the information on the capability of supporting the reflective QoS of the UE can be provided to the network in a form of subscriber information. In this case, the UE may not provide a separate notification on the capability of supporting the reflective QoS of the UE to the network node. The subscriber information including the information on the capability of supporting the reflective QoS of the UE can be stored in the HSS. The HSS can provide the information on the capability of supporting the reflective QoS of the UE to the network node via an explicit signaling. Or, the HSS may provide information capable of analogizing the capability of supporting the reflective QoS of the UE to the network node only. By doing so, the network node may implicitly identify the capability of supporting the reflective QoS of the UE from different information (or from a combination of different informations).

In this case, since a UE relevant to whether the reflective QoS is supported corresponds to a 3GPP UE passing through a non-3GPP access, a network node in relation to such an operation as authentication and the like for the UE may correspond to a 3GPP AAA server. In particular, the UE supporting the reflective QoS can inform the 3GPP AAA server of a corresponding fact in the course of the authentication process. Or, a node (e.g., MME, etc.) in charge of an operation on a control plane may operate as the network node. And, the information on the capability of supporting the reflective QoS of the UE may be delivered to the 3 GPP AAA server via a different network node (e.g., BBF AAA server).

According to the aforementioned scheme 1, the network node can determine whether to apply the reflective QoS to the UE based on the capability of supporting the reflective QoS of the UE, a type of access, a local policy, HPLMN service provider (i.e., a home service provider of a subscriber) policy, or the like. In doing so, the network node can indicate the UE whether the reflective QoS is applied. For instance, the network node can perform a decision on whether to apply the reflective QoS to the UE as a part of AAA signaling for UE authentication.

A second scheme relates to a scheme for a UE to determine whether to apply the reflective QoS.

In order for the UE to determine whether to apply the reflective QoS, basically, the decision should be made based on information on whether the UE is equipped with the capability of supporting the reflective QoS. The information corresponds to information already known to the UE itself. In addition, the UE can determine whether to apply the reflective QoS based on a type of access, a local policy, HPLMN service provider (i.e., a home service provider of a subscriber) policy, or the like.

In this case, the service provider policy, the local network policy, a policy of a broadband access network, or the like can be delivered to the UE via such a method as OMA DM (open mobile alliance device management), OTA (over the air), or the like. And, the UE can determine a type (e.g., WLAN) of an access network to which the UE currently intends to attach (or has attached). Or, if there exists a predetermined rule or condition on whether to apply the reflective QoS, the UE may be aware of the predetermined rule or condition in advance.

As a scheme 2-1, the UE determines whether to apply the reflective QoS based on the capability of supporting the reflective QoS, a type of access, a local policy and/or a HPLMN service provider (i.e., a home service provider of a subscriber) policy and can indicate a decision to the network node. For instance, the UE can inform the network node of the decision in the course of an attachment process (e.g., in the course of an access authentication process or IKEv2 tunnel establishing process) or in an upper application level after the attachment.

As a scheme 2-2, although the UE makes a decision on whether to apply the reflective QoS, the UE can make the network finally judge whether the reflective QoS is applied. Hence, the UE can deliver a request for whether to apply the reflective QoS to the network node and may operate according to an indication of the network node indicating whether the reflective QoS is applied.

In addition, a legacy reflective QoS is applied in a UE granularity. In particular, according to the legacy system, it is defined that the reflective QoS may or may not be applied to all UL transmissions of a prescribed UE. According to the legacy system, the reflective QoS is applied to a prescribed application. Meanwhile, for a different application, a scheme of applying a QoS level to which the prescribed application is mapped cannot be supported. Hence, the present invention proposes that the reflective QoS is applied in an application granularity. And, the reflective QoS may be applied in a PDN connection granularity, an APN granularity, or traffic granularity (e.g., an audio, a video, the internet, or the like). Moreover, priority of applying the reflective QoS can be configured according to the application, the PDN connection, the APN, or the traffic granularity. The configuration of the reflective QoS application granularity and/or priority can be performed in case that the UE establishes or updates the PDN connection, configures a new bearer, updates a bearer, or the like.

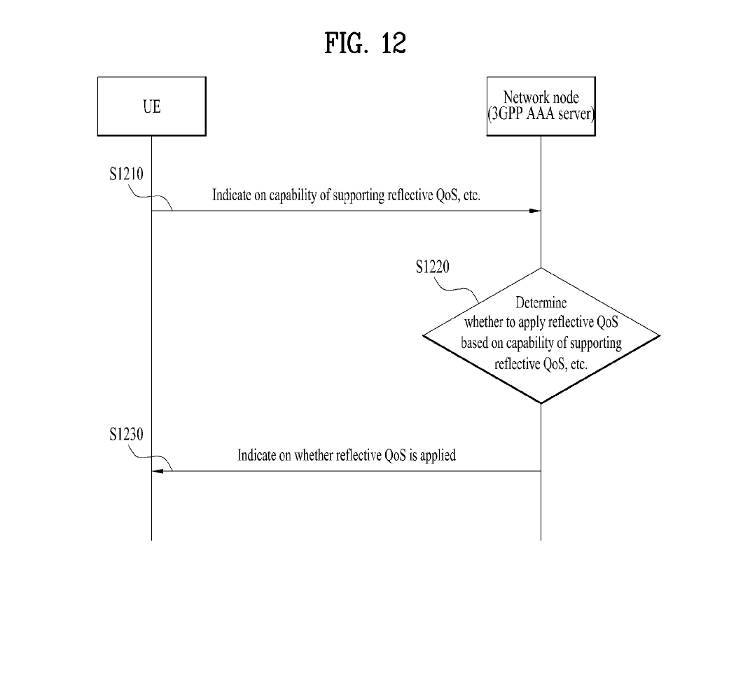

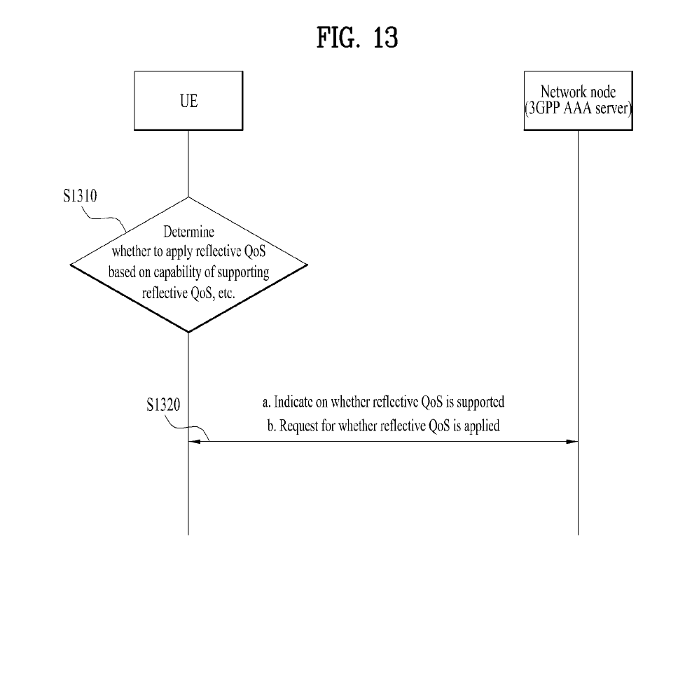

FIG. 12 is a flowchart indicating a method of determining whether to apply a reflective QoS according to one example of the present invention.

In the step S1210, a UE can inform a network node (e.g., 3GPP AAA server) of a capability of supporting the reflective QoS and the like. In this case, activation/inactivation state information on the capability of supporting the reflective QoS may also be provided to the network node. The state information is not additional information but information explicitly/implicitly included in the information indicating whether the reflective QoS is supported. In particular, it is not mandatory for the UE to explicitly inform the network of the information on the capability of supporting the reflective QoS. It may be sufficient for the UE to inform that the UE has an intention of using a reflective QoS function. And, in the step S1210, a message for delivering the information on the capability can be implemented in a manner that a new parameter is added to a legacy control signaling. Or, a new control signaling can be defined or used for the message.

In the step of S1220, the network node can determine or evaluate whether to apply the reflective QoS based on the information on the capability of supporting reflective QoS of the UE. Whether to apply the reflective QoS can be determined based on at least one selected from the group consisting of the information on the capability of supporting the reflective QoS of the UE (including the activation/inactivation state information), information on the capability of performing the reflective QoS of the network node, information on an access network to which the UE intends to access or has accessed, HPLMN/VPLMN service provider policy information on whether to use the reflective QoS, and predetermined information. In this case, for instance, the predetermined information may correspond to a rule that the reflective QoS is permitted to a prescribed object but is not permitted to a different object. For instance, this sort of rules may be predetermined according to an access network, a UE, and/or a PDN (or APN).

In the step S1230, the network node may inform the UE of the decision (i.e., whether the reflective QoS is applied) made in the step S1220. For instance, the network node may inform the UE that the UE should use or should not use the reflective QoS function. Or, the network node may inform the UE that the UE activates or inactivates the capability of supporting the reflective QoS.

FIG. 13 is a flowchart indicating a method of determining whether to apply a reflective QoS according to a different example of the present invention.

In the step S1310, the UE can judge whether to apply the reflective QoS. For instance, the UE can determine whether to apply the reflective QoS based on at least one selected from the group consisting of information on the capability of supporting the reflective QoS of the UE, information on an access network to which the UE intends to access or has accessed, HPLMN/VPLMN service provider policy information on whether to use the reflective QoS, and predetermined information (whether the reflective QoS is permitted according to an object/case and the like).

In the step S1320, the UE may indicate a decision on whether the reflective QoS is supported to the network node [S1320-a] or may request that the network makes a final decision on whether to apply the reflective QoS [S1320-b].

The step S1320-a corresponds to a direct notification of the UE on whether the UE uses the reflective QoS function or not. The UE may or may not apply the reflective QoS function without a separate indication from the network. Or, the network node may transmit a response message simply indicating whether the network has properly received the notification of the UE notifying whether the UE uses the reflective QoS function or not.

Meanwhile, the step S1320-b can be performed as a request necessary for the network to perform the reflective QoS (e.g., want or does not want to use the reflective QoS) after the UE determines that the reflective QoS is available. This sort of request messages can be provided to the network node in a manner of explicitly or implicitly including the information on the capability of supporting the reflective QoS of the UE and/or the information on activation/inactivation state of the capability.

As depicted in the step S1220 of FIG. 12, having received the request, the network node can make a final decision on whether to apply the reflective QoS to the network. For instance, in addition to the content mentioned earlier in the step S1220, the network node can determine whether to apply the reflective QoS to the UE based on the request (the request requested by the UE in the step S1320-b) of the UE.

Subsequently, as depicted in the step S1230 of FIG. 12, the network node can inform the UE of a decision on whether the reflective QoS is applied. And, the network node may inform the UE of whether the network node has received the request (the request requested in the step S1320-b) of the UE or not.

And, the notification message in the step of S1320-a or the request message in the step of S1320-b can be implemented in a manner that a new parameter is added to a legacy control signaling. Or, a new control signaling can be defined or used for the messages.

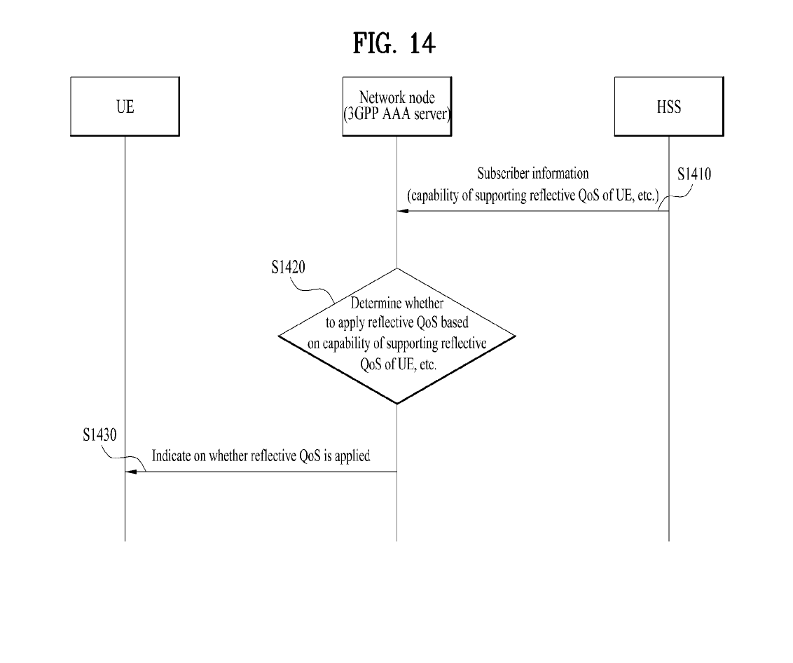

FIG. 14 is a flowchart indicating a method of determining whether to apply a reflective QoS according to a further different example of the present invention.

In the step S1410, the HSS can provide subscriber information including the information on the capability of supporting the reflective QoS of the UE to the network node. In this case, activation/inactivation state information on the capability of supporting the reflective QoS can also be provided to the network node. The state information is not additional information but information explicitly/implicitly included in the information indicating whether the reflective QoS is supported. In particular, it is not mandatory for the HSS to explicitly inform the network of the information on the capability of supporting the reflective QoS of the UE. It may be sufficient for the HSS to inform that the UE has an intention of using a reflective QoS function. And, a message for delivering the information on the capability of supporting the reflective QoS of the UE can be implemented in a manner that a new parameter is added to a legacy control signaling. Or, a new control signaling can be defined or used for the message.

Similar to the step S1220 of FIG. 12, the network node can determine whether to apply the reflective QoS in the step S1420. For instance, in addition to the content mentioned earlier in the step S1220, the network node can determine whether to apply the reflective QoS to the UE based on subscriber information received from the HSS or information on application of the reflective QoS of the UE received from a different specific server (e.g., BBF AAA server).

In the step S1430, as depicted in the step S1230, the network node can transmit an indication indicating whether the reflective QoS is applied to the UE.

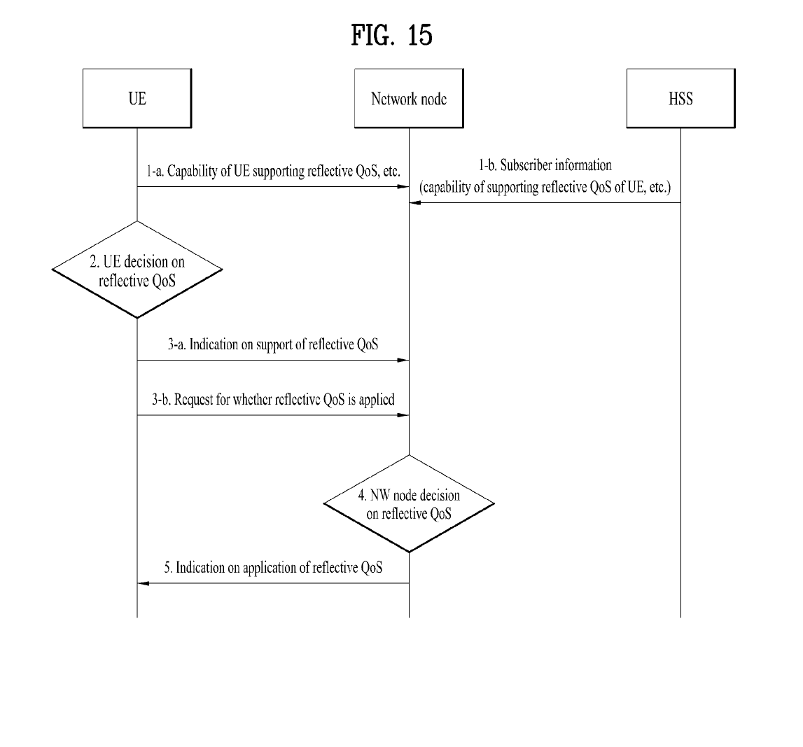

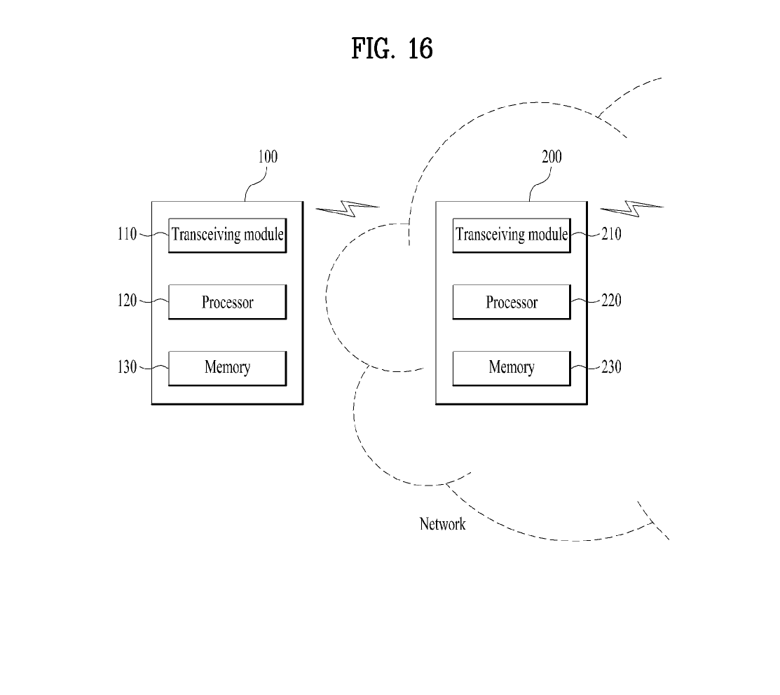

FIG. 15 is a flowchart indicating a method of determining whether to apply a reflective QoS according to a further different example of the present invention.

Since the step S1-a of FIG. 15 corresponds to the step S1210 of FIG. 12 and the step S1-b of FIG. 15 corresponds to the step S1410 of FIG. 14, duplicated explanation is omitted. It is not necessary to perform the step S1-a and the step S1-b of FIG. 15 prior to the step S2 or the step S3-a/3-b described in the following. The step S1-a and the step s1-b can be performed prior to a timing point that the network node needs the information on the capability of supporting the reflective QoS of the UE.

Since the step S2 of FIG. 15 corresponds to the step S1310 of FIG. 13, duplicated explanation is omitted.

Since the step S3-a and the step S3-b of FIG. 15 correspond to the step S1320-a and the step S1320-b of FIG. 13, respectively, duplicated explanation is omitted.

The step S4 of FIG. 15 corresponds to the step S1220 of FIG. 12 or the step S1420 of FIG. 14. For instance, the network node can determine whether to apply the reflective QoS to the UE based on the information on the capability of supporting reflective QoS of the UE, a type of access, a local policy, HPLMN service provider (i.e., a home service provider of a subscriber) policy, or the like. And, the network node can evaluate the notification of the UE in the step S3-a of FIG. 15 or the request of the UE in the step S3-b of FIG. 15.

The step S5 of FIG. 15 corresponds to the step S1230 of FIG. 12 or the step S1430 of FIG. 14. For instance, the network node may inform the UE of whether the function of the reflective QoS is used, whether the network node recognizes the notification of the UE, whether the request of the UE is accepted, whether the capability of supporting the reflective QoS of the UE is activated or inactivated, and the like. Meanwhile, as shown in the step S3-a of FIG. 15, if the UE notifies that the UE will use the reflective QoS function, the step 5 of FIG. 15 may not be performed.

And, in the steps of S1-a, S1-b, S3-a, and S3-b of FIG. 15, although the network node may correspond to an identical single network node as a main agent of receiving a message, a different network node may receive the message. This sort of node may correspond to such a node in charge of a control signaling on a control plane as AAA server, MME, and the like.

Various embodiments of the present invention may be applied to various cases of a BBF interworking structure. For instance, the reflective QoS scheme of the present invention may be applied to at least one of the BBF interworking structures depicted in FIG. 6 to FIG. 8.

The contents explained in the aforementioned various embodiments of the present invention can be independently applied or two or more embodiments can be simultaneously applied.

FIG. 16 is a diagram for a configuration of a preferred embodiment for a user equipment device and a network node device according to one example of the present invention.

Referring to FIG. 16, a user equipment device 100 can include a transceiving module 110, a processor 120 and a memory 130. The transceiving module 110 can be configured to transmit various signals, data, and information to the external and configured to receive various signals, data, and information from the external. The user equipment device 100 can be connected with an external device in wired and/or wireless. The processor 120 can control overall operations of the user equipment device 100. The processor can be configured to perform a function of calculating information and the like to be transceived with the external device. The memory 130 can store the calculated information for a predetermined time and may be replaced with such a configuration element as a buffer (not depicted) or the like.

The user equipment device 100 according to one embodiment of the present invention can be configured to manage UL quality of service (QoS). In case that the user equipment 100 supports reflective QoS, the processor 120 of the user equipment device 100 can be configured to transmit an indication related to the reflective QoS to a network node 200 using the transceiving module 110. And, the processor 120 of the user equipment device 100 can be configured to receive an indication on whether the reflective QoS is applied from the network node in response to the indication of the user equipment 100 using the transceiving module 110.

Referring to FIG. 16, a network node device 200 can include a transceiving module 210, a processor 220 and a memory 230. The transceiving module 210 can be configured to transmit various signals, data, and information to the external and configured to receive various signals, data, and information from the external. The network node device 200 can be connected with an external device in wired and/or wireless. The processor 220 can control overall operations of the network node device 200. The processor can be configured to perform a function of calculating information and the like to be transceived with the external device. The memory 230 can store the calculated information for a predetermined time and may be replaced with such a configuration element as a buffer (not depicted) or the like.

The network node device 200 according to one embodiment of the present invention can be configured to support management of UL quality of service (QoS) of the user equipment. In case that the user equipment 100 supports reflective QoS, the processor 220 of the network node device 200 can be configured to receive an indication related to the reflective QoS from the user equipment 100 using the transceiving module 210. And, the processor 220 of the network node device 200 can be configured to transmit an indication on whether the reflective QoS is applied to the user equipment 100 in response to the indication of the user equipment 100 using the transceiving module 210.

Detail configuration of the user equipment device 100 and the network device 200 can be implemented in a manner that the aforementioned items explained in various embodiments of the present invention are independently applied or two or more embodiments are simultaneously applied. For clarity, duplicated contents are omitted.

Embodiments of the present invention can be implemented using various means. For instance, embodiments of the present invention can be implemented using hardware, firmware, software and/or any combinations thereof.

In the implementation by hardware, a method according to each embodiment of the present invention can be implemented by at least one selected from the group consisting of ASICs (application specific integrated circuits), DSPs (digital signal processors), DSPDs (digital signal processing devices), PLDs (programmable logic devices), FPGAs (field programmable gate arrays), processor, controller, microcontroller, microprocessor and the like.

In case of the implementation by firmware or software, a method according to each embodiment of the present invention can be implemented by modules, procedures, and/or functions for performing the above-explained functions or operations. Software code is stored in a memory unit and is then drivable by a processor. The memory unit is provided within or outside the processor to exchange data with the processor through the various means known in public.

Detailed explanation on the preferred embodiment of the present invention disclosed as mentioned in the foregoing description is provided for those in the art to implement and execute the present invention. While the present invention has been described and illustrated herein with reference to the preferred embodiments thereof, it will be apparent to those skilled in the art that various modifications and variations can be made therein without departing from the spirit and scope of the invention. For instance, those skilled in the art can use each component described in the aforementioned embodiments in a manner of combining it with each other. Hence, the present invention may be non-limited to the aforementioned embodiments of the present invention and intends to provide a scope matched with principles and new characteristics disclosed in the present invention.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

### INDUSTRIAL APPLICABILITY

The aforementioned embodiments of the present invention can be applied to various mobile communication systems.

What is claimed is:

1. A method of managing uplink quality of service (QoS) of a user equipment, comprising the steps of:
if the user equipment supports a reflective QoS, transmitting an indication on the reflective QoS to a network node; and
receiving an indication on whether the reflective QoS is applied from the network node in response to the indication of the user equipment.

2. The method of claim 1, wherein the indication on the reflective QoS is transmitted to the network node during an authentication process of the user equipment.

3. The method of claim 1, wherein a decision on whether the reflective QoS is applied is contained in the authentication process of the user equipment.

4. The method of claim 1, wherein whether to apply the reflective QoS is determined based on at least one of a capability of the user equipment related to the reflective QoS, a type of access, a local policy, or a policy of a HPLMN (Home Public Land Mobile Network) service provider.

5. The method of claim 1, wherein the network node corresponds to a 3GPP (3^{rd} Generation Partnership Project) AAA (Authentication, Authorization and Accounting) server.

6. The method of claim 1, wherein the method of managing the UL QoS is applied to interworking between a 3GPP and a fixed broadband access.

7. The method of claim 1, wherein a DSCP (Differentiated Service Code Point) marking is performed by the user equipment using the reflective QoS.

8. The method of claim 1, wherein the user equipment accesses via a wireless LAN.

9. The method of claim 1, wherein the reflective QoS is applied to a traffic being routed to an EPC (Evolved Packet Core) via a wireless LAN.

10. The method of claim 1, wherein the reflective QoS is configured in a granularity of an application, a PDN (Packet Data Network) connection, or an APN (Access Point Name).

11. A method of supporting uplink quality of service (QoS) of a user equipment, which is supported by a network node, comprising the steps of:
if the user equipment supports a reflective QoS, receiving an indication on the reflective QoS from the user equipment by the network node; and
transmitting an indication on whether the reflective QoS is applied to the user equipment by the network node in response to the indication of the user equipment.

12. A user equipment device managing uplink quality of service (QoS), comprising:
a transceiving module configured to transceive a signal with an external; and
a processor configured to control the user equipment device,
if the user equipment supports a reflective QoS, the processor configured to transmit an indication on the reflective QoS to a network node using the transceiving module, the processor configured to receive an indication on whether the reflective QoS is applied from the network node in response to the indication of the user equipment using the transceiving module.

13. A network node device supporting management of uplink quality of service (QoS) of a user equipment, comprising:
a transceiving module configured to transceive a signal with an external; and
a processor configured to control the network node device,
if the user equipment supports a reflective QoS, the processor configured to receive an indication on the reflective QoS from the user equipment using the transceiving module, the processor configured to transmit an indication on whether the reflective QoS is applied to the user equipment in response to the indication of the user equipment using the transceiving module.
